(19) United States
(12) Patent Application Publication
(10) Pub. No.: US 2008/0203318 A1
(43) Pub. Date: Aug. 28, 2008

(54) Alignment Adapter for Use with a Radioisotope Generator and Methods of Using the Same

(76) Inventors: Gary S. Wagner, Independence, KY (US); David W. Wilson, Loveland, OH (US); Frank F. Fago, Mason, OH (US); Ralph E. Pollard, Fairfield, OH (US)

Correspondence Address: Mallinckrodt Inc., 675 McDonnell Boulevard, HAZELWOOD, MO, 63042, US

(21) Appl. No.: 11/995,721

(22) PCT Filed: Jul. 26, 2006
(86) PCT No.: PCT/US06/29057

§ 371 Date: Jan. 15, 2008

Related U.S. Application Data
(60) Provisional application No. 60/703,036, filed on Jul. 27, 2005.

(51) Int. Cl. G21F 5/015

(52) U.S. Cl. 250/432 PD

(57) ABSTRACT

The invention, in one characterization, may be said to be directed to an alignment adapter that may be utilized in radioisotope elution procedures. In some embodiments, the alignment adaptor may be utilized to at least assist in aligning various components of an elution system. For example, in some embodiments, the alignment adaptor may be utilized to at least generally assist in aligning an aperture defined in a lid of the elution system and an elution needle of a radioisotope generator. In some embodiments, the alignment adaptor may be utilized to at least generally assist in aligning an elution assembly (e.g., elution shield housing an eluate vial) and an elution needle of a radioisotope generator. Further, in some embodiments, the alignment adaptor may be utilized to at least generally assist in aligning an eluant container (e.g., bottle of eluant) and a needle of a radioisotope generator.

### FIELD OF THE INVENTION

The invention relates generally to the field of nuclear medicine. Specifically, the invention relates to a systems and methods for aligning components of an elution system configured to enable extraction (e.g., via an elution assembly) of a radioactive material for use in nuclear medicine from a radioisotope generator.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Nuclear medicine utilizes radioactive material for diagnostic and therapeutic purposes by injecting a patient with a small dose of the radioactive material, which concentrates in certain organs or biological regions of the patient. Radioactive materials typically used for nuclear medicine include Technetium-99 m, Indium-113 m, and Strontium-87 m among others. Some radioactive materials naturally concentrate toward a particular tissue, for example, iodine concentrates toward the thyroid. However, radioactive materials are often combined with a tagging or organ-seeking agent, which targets the radioactive material for the desired organ or biologic region of the patient. These radioactive materials alone or in combination with a tagging agent are typically defined as radiopharmaceuticals in the field of nuclear medicine. At relatively lower doses of the radiopharmaceutical, a radiation imaging system (e.g., a gamma camera) provides an image of the organ or biological region that collects the radiopharmaceutical. Irregularities in the image are often indicative of a pathologic condition, such as cancer. Higher doses of the radiopharmaceutical are used to deliver a therapeutic dose of radiation directly to the pathologic tissue, such as cancer cells.

A variety of systems are used to generate, enclose, transport, dispense, and administer radiopharmaceuticals. These systems often involve manual alignment of components, such as male and female connectors of containers. Unfortunately, the male connectors can be damaged due to misalignment with the corresponding female connectors. For example, hollow needles can be bent, crushed, or broken due to misalignment with female connectors. As a result, the systems operate less effectively or become completely useless. If the systems contain radiopharmaceuticals, then the damaged connectors can result in monetary losses, delays with respect to nuclear medicine procedures, and/or undesired exposure of technicians (or other personnel) to radiation.

### SUMMARY

The present invention, in certain embodiments, is directed to alignment of components in a radioisotope elution system. In one regard, the invention may be said to be directed to an alignment adapter that may be utilized in radioisotope elution procedures. For instance, the alignment adaptor may be utilized to at least assist in aligning various components of a radioisotope generator and/or to at least generally assist in aligning an elution assembly (e.g., an elution shield having an eluate vial or the like disposed therein) and a component (e.g., a hollow needle of) a radioisotope generator. This alignment adapter generally includes a body and an outer wall at an outer perimeter of the body. The outer wall may be shaped to fit closely with dimensions of a receptacle of an auxiliary shield in which a radioisotope generator may be at least partially disposed. The alignment adapter may have an inner structure at an inner region of the body that may be shaped to fit closely with dimensions of a top portion of the generator. Additionally or alternatively, the alignment adapter may include one or more passages that extend through the body thereof. The one or more passages may be shaped to fit closely with dimensions of the elution assembly, an eluant container, or a combination thereof. In some embodiments, the one or more passages may be substantially centered relative to one or more desired components (e.g., hollow needles) of the generator.

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of features and aspects that may not be set forth below.

In accordance with a first aspect of the present invention, there is provided an elution system having a radioisotope generator, an eluant container, and an alignment adapter having an eluant alignment portion and an eluate alignment portion coupled together. The alignment adapter may be disposed between the radioisotope generator and the eluant container. The eluant container may be substantially aligned in a releasable connection with the radioisotope generator by the eluant alignment portion. For example, the eluant alignment portion may include a first passage closely fit about the eluant container and aligned with an inlet hollow needle of the radioisotope generator. By further example, the eluate alignment portion may include a second passage aligned with an outlet hollow needle of the radioisotope generator.

In accordance with a second aspect of the present invention, there is provided an alignment adapter for a radioisotope generator assembly. The alignment adapter may include a body having a radioisotope generator alignment structure coupled to the body. The alignment adapter may have a first container alignment passage disposed through the body. In addition, the alignment adapter may have a second container alignment passage disposed through the body adjacent the first container passage.

In accordance with a third aspect of the present invention, there is provided a radioisotope generator assembly. The assembly may include a radioisotope generator having a first hollow needle disposed at a top portion of the generator. The assembly also may have an alignment adapter closely fit with the top portion of the generator. In addition, the alignment adapter may have a first passage substantially centered relative to the first hollow needle. The first passage may be shaped to fit closely with dimensions of a first container coupleable (i.e., capable of being coupled) with the first hollow needle. The alignment adapter also may include an elution viewing window extending into the first passage.

In accordance with a fourth aspect of the present invention, there is provided a method that may include guiding a first container through a closely fit first passage of a structure releasably attached to a radioisotope generator and into substantially centered engagement with a first hollow needle of a radioisotope generator. The method may also include guiding a second container through a closely fit second passage in the structure and into engagement (e.g., substantially centered engagement) with a second hollow needle of the radioisotope generator.

In accordance with a fifth aspect of the present invention, there is provided an elution system having a radioisotope generator. The system may have an auxiliary radiation shield defining a receptacle and an opening into the receptacle, and a cover removably disposed across the opening, wherein the radioisotope generator may be disposed inside the receptacle. In addition, the system may have at least one alignment adapter disposed inside the auxiliary radiation shield between the radioisotope generator and the cover. A passage through the cover may be aligned with at least one connector of the radioisotope generator via the alignment adapter(s).

In accordance with a sixth aspect of the present invention, there is provided a lid plug for a radioisotope generator assembly. The lid plug may include a body having a radioactive shielding material. The body may have a head portion and a fitted-mounting alignment portion coupled to the head portion. The fitted-mounting alignment portion may be disposed along at least a substantial portion of a length of the body. The body may have a receptacle disposed inside the fitted-mounting alignment portion. A hollow needle passage may be disposed at an end of the body. This hollow needle passage may be aligned with the receptacle. Furthermore, the lid plug may have a container disposed inside the receptacle, wherein an inlet of the container may be aligned with the hollow needle passage.

Various refinements exist of the features noted above in relation to the various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### BRIEF DESCRIPTION OF THE FIGURES

These and other features, aspects, and advantages of the present invention will become better understood when the following detailed description is read with reference to the accompanying figures in which like characters represent like parts throughout the figures, wherein:

FIG. 1 is a side view of an exemplary radioisotope elution system including a radioisotope generator disposed in an auxiliary shield and a shielded elution assembly disposed through an opening in a lid of the elution system;

FIG. 2 is a cross-sectional side view of the elution system of FIG. 1, further illustrating an alignment adapter for aligning various components (e.g., two or more of the shielded elution assembly, the opening in the lid, an eluant container, the radioisotope generator, hollow needles of the radioisotope generator, and the auxiliary shield) with one another;

FIG. 3 is a bottom perspective exploded view of the elution system of FIG. 2;

FIG. 4 is a top perspective exploded view of the elution system of FIG. 2;

FIG. 5 is a top perspective view of the elution system of FIG. 2, illustrating the radioisotope generator disposed inside the auxiliary shield without the alignment adapter, eluant container, and shielded elution assembly;

FIG. 6 is a bottom view of the alignment adapter of FIGS. 3 and 4;

FIG. 7 is a side view of the alignment adapter of FIGS. 3 and 4;

FIG. 8 is a bottom perspective view of the alignment adapter of FIGS. 3 and 4;

FIG. 9 is a top perspective view of the alignment adapter of FIGS. 3 and 4;

FIG. 10 is a top perspective view of the elution system of FIG. 5, further illustrating the alignment adapter of FIGS. 3, 4, 6, and 7 disposed atop the radioisotope generator inside the auxiliary shield;

FIG. 11 is a cross-sectional side view of the elution system of FIG. 10, further illustrating the eluant container of FIGS. 3 and 4 partially lowered through a lower passage in the alignment adapter above an inlet needle of the radioisotope generator;

FIG. 12 is a top view of the elution system of FIG. 11;

FIG. 13 is a bottom perspective view of the lid of FIGS. 1-4, further illustrating a supplemental alignment adapter coupled to an underside of the lid;

FIG. 14 is a top perspective view of the elution system of FIGS. 11 and 12, further illustrating the lid of FIGS. 1-4 and 11 disposed over and covering an opening into the auxiliary shield;

FIG. 15 is a partial bottom perspective view of the elution system of FIG. 14 without the auxiliary shield for illustration of an exemplary interaction between the alignment adapter and the supplemental alignment adapter;

FIG. 16 is a partial cross-sectional side view of the elution system of FIG. 15, further illustrating the shielded elution assembly partially lowered through a passage in the lid and an upper protruded passage of the alignment adapter;

FIG. 17 is a partial cross-sectional side view of the elution system of FIG. 16 taken through a section 15-15;

FIG. 18 is a top perspective view of the elution system of FIGS. 16 and 17, further illustrating the shielded elution assembly fully lowered into the elution system;

FIG. 19 is a top perspective view of the elution system of FIGS. 16 and 17, further illustrating a lid plug (rather than the shielded elution assembly) lowered into and closing off the passage in the lid of the elution system;

FIG. 20 is a partial perspective exploded view of the elution system 10 of FIG. 19, furthering illustrating one embodiment of the lid plug having a C-shaped alignment sleeve adapted to facilitate alignment with the upper protruded passage of the alignment adapter;

FIG. 21 is a bottom perspective exploded view of the lid plug of FIG. 20;

FIG. 22 is a partial perspective exploded view of the elution system 10 of FIG. 19, illustrating another embodiment of the lid plug having a semi-cylindrical structure along a substantial portion of the length of the lid plug to facilitate alignment with the upper protruded passage of the alignment adapter;

FIG. 23 is a bottom perspective exploded view of the lid plug of FIG. 22;

FIG. 24 is a perspective exploded view of another alternative embodiment of the lid plug illustrated in FIG. 19, illustrating a lateral access receptacle adapted to facilitate lateral insertion and removal of a sterile fluid container;

FIG. 25 is a flow chart illustrating an exemplary nuclear medicine process utilizing a radioisotope obtained via use of the elution system of FIGS. 1-24;

FIG. 26 is a block diagram illustrating an exemplary system for providing a container, such as a syringe, having a radiopharmaceutical (including a radioisotope obtained using the elution system of FIGS. 1-24) disposed therein; and

FIG. 27 is a block diagram illustrating an exemplary nuclear medicine imaging system utilizing the syringe (including the radiopharmaceutical) of FIG. 26.

### DETAILED DESCRIPTION OF SPECIFIC EMBODIMENTS

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

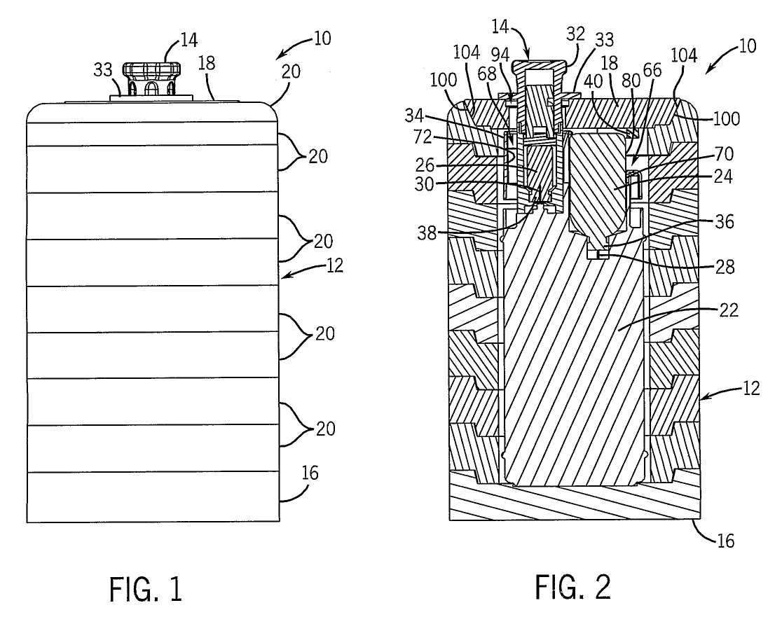

FIG. 1 is a side view of an exemplary elution system 10 including an auxiliary shield 12 and a shielded elution assembly 14. As discussed in further detail below, a variety of alignment adapters, sleeves, and/or mechanisms may be incorporated into the elution system 10 to facilitate proper alignment of the various containers, hollow needles, radioisotope generator, and other components residing inside the auxiliary shield 12. The auxiliary shield 12 includes a base 16, a lid 18, and a plurality of step-shaped or at least generally tiered modular rings 20 disposed one over the other between the base 16 and the lid 18 (see FIG. 2). The illustrated auxiliary shield 12 may be made of lead and/or another suitable radiation shielding material to substantially contain radioactivity within the confines of the auxiliary shield 12. Moreover, the modularity of the rings 20 enables flexibility in the height of the auxiliary shield 12, while the step-shaped configuration provides proper radiation containment. While one example of an auxiliary shield is shown and described, it should be noted that other auxiliary shields may be appropriately employed.

FIG. 2 is a cross-sectional side view of the elution system 10 of FIG. 1, further illustrating a radioisotope generator 22, an eluant container 24, and an elution output or eluate container 26 disposed within the confines of the auxiliary shield 12. Herein, an “eluant container” refers to a container that has or had an appropriate elution source fluid (e.g., saline) disposed therein. In contrast, an “eluate container” refers to a container that receives or is at least generally designed to receive a liquid solution or the like that is produced in an elution procedure. As illustrated, the eluant container 24 is coupled to the radioisotope generator 22 via one or more inlet hollow needles 28 (e.g., a pair of hollow needles), while the eluate container 26 is coupled to the radioisotope generator 22 via one or more outlet hollow needles 30 (e.g., a single hollow needle). When coupled to the radioisotope generator 22, the containers 24, 26 may be said to be in fluid communication with the radioisotope generator 22 (e.g., associated in a manner that enables fluid to flow between the containers 24, 26 and the generator 22). The eluate container 26 is disposed inside an elution shield 32 of the shielded elution assembly 14. The elution shield 32 may be made of lead, tungsten, tungsten impregnated plastic and/or another suitable radiation shielding material. As discussed in further detail below, an alignment adapter 34 may be disposed between the radioisotope generator 22 and the lid 18 to facilitate proper alignment of the containers 24, 26 and hollow needles 28, 30 during assembly, disassembly, and/or use of the elution system 10. The alignment adapter 34 may reduce a likelihood of the hollow needles 28, 30 being inadvertently misaligned, bent, crushed, or otherwise damaged when being coupled with and/or disconnected from the containers 24, 26. In certain embodiments, the alignment adapter 34 is a molded plastic structure, which can include one or more radiation shielding materials (e.g., tungsten impregnated plastic). In such embodiments, the elution system 10 may or may not include the lid 18 since the alignment adapter 34 may be designed to provide at least some radiation shielding.

In operation, an eluant inside the eluant container 24 is circulated through the inlet hollow needles 28, throughout the radioisotope generator 22, and out through the outlet hollow needle 30 into the eluate container 26. The forgoing circulation of the eluant washes out or generally extracts a radioactive material, e.g., a radioisotope, from the radioisotope generator 22 into the eluate container 26. For example, one embodiment of the radioisotope generator 22 includes a radioactive shielded outer casing (e.g., lead shell) that encloses a radioactive parent, such as molybdenum-99, adsorbed to the surfaces of beads of alumina or a resin exchange column. Inside the radioisotope generator 22, the parent molybdenum-99 transforms, with a half-life of about 67 hours, into metastable technetium-99m. The daughter radioisotope, e.g., technetium-99m, is generally held less tightly than the parent radioisotope, e.g., molybdenum-99, within the radioisotope generator 22. Accordingly, the daughter radioisotope, e.g., technetium-99m, can be extracted or washed out with a suitable eluant, such as an oxidant-free physiologic saline solution. Upon collecting a desired amount (e.g., desired number of doses) of the daughter radioisotope, e.g., technetium-99m, within the eluate container 26, the shielded elution assembly 14 can be removed from the elution system 10. As discussed in further detail below, the extracted daughter radioisotope can then, if desired, be combined with a tagging agent to facilitate diagnosis or treatment of a patient (e.g., in a nuclear medicine facility).

In view of the operation of the elution system 10, proper alignment of the various components may be particularly important to the life of the inlet and outlet hollow needles 28, 30 and, thus, proper circulation of the eluant from the eluant container 24 through the radioisotope generator 22 and into the eluate container 26. The illustrated elution system 10 includes the alignment adapter 34 to facilitate alignment of the eluant container 24 with the inlet hollow needles 28 and to facilitate alignment of the eluate container 26 with the outlet hollow needle 30. As discussed in further detail below, the alignment adapter 34 enables a technician to guide each of the containers 24, 26 in a desired (e.g., substantially straight) direction toward the respective hollow needles 28, 30, such that the hollow needles 28, 30 enter straight into desired locations (e.g., centers) of respective ends 36, 38 of the containers 24, 26. In this manner, the alignment adapter 34 may substantially reduce or eliminate the possibility of misalignment and accidental bends or breaks of the hollow needles 28, 30 when being coupled with the containers 24, 26, respectively.

Certain embodiments of the alignment adapter 34 substantially reduce the play, clearance, or general freedom of lateral movement between the various containers 24, 26, the auxiliary shield 12, the lid 18, the generator 22, and/or the hollow needles 28, 30, such that proper alignment and generally straight (e.g., upward and/or downward) movement of the components can be achieved during assembly and disassembly. Although some clearance or play may remain between the components, the clearance is generally reduced to provide a relatively close fit that increases the likelihood that the components will travel in a generally straight and aligned direction during assembly and disassembly. A “closely fit interface” or the like between components herein refers to a substantially reduced distance between at least portions of the components, which distance is selected to reduce the likelihood for tilting, laterally shifting, or general misalignment relative to a desired direction (e.g., straight up or down) of movement (e.g., along a centerline of the components). The alignment adapter 34 includes lengthwise guiding structures (e.g., passages 66, 68 as discussed below) in the direction of the insertion and removal of components, e.g., downward insertion and upward removal of the containers 24, 26 relative to the generator 22. The lengthwise guiding structures may effectively increase the length of guidance (e.g., of the containers 24, 26) in the direction of insertion and removal, thereby potentially reducing the likelihood (or possible degree) of tilting and shifting relative to the direction of insertion and removal. Altogether, the closely fit interface between components (e.g., interface between containers 24, 26 and passages 66, 68) and the lengthwise guiding structures (e.g., passages 66, 68) may, at least in one regard, cooperatively increase the likelihood for proper alignment and connection between the components (e.g., containers 24, 26 and hollow needles 28, 30). Various aspects of the alignment adapter 34 are described in detail below with reference to the subsequent figures.

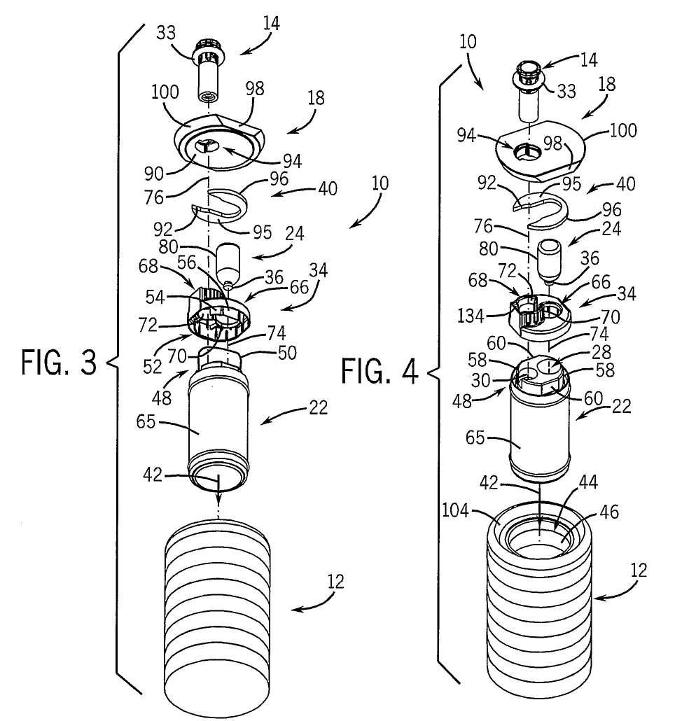

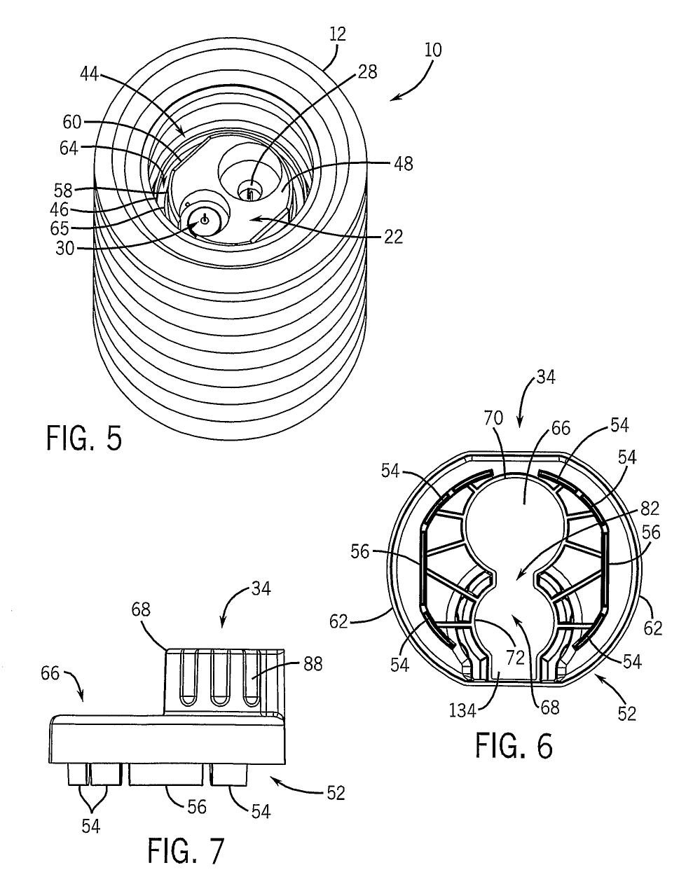

FIGS. 3 and 4 are bottom and top perspective exploded views of the elution system 10 of FIG. 2, illustrating alignment functions of the alignment adapter 34 and a supplemental alignment adapter 40 relative to the various components. As indicated by arrow 42, the radioisotope generator 22 may be lowered through an upper opening 44 into a cylindrical receptacle 46 of the auxiliary shield 12, such that a top portion 48 of the radioisotope generator 22 faces upward toward the upper opening 44. As illustrated FIG. 3, the radioisotope generator 22 may include an appropriate handle such as a flexible handle 50 to facilitate lowering of the radioisotope generator 22 into the auxiliary shield 12. Although not shown in FIG. 4, the flexible handle 50 may be generally laid down in the region of the top portion 48 of the radioisotope generator 22 upon completely lowering the auxiliary shield 12. Before or after lowering the radioisotope generator 22, the alignment adapter 34 may be associated with (e.g., fit about) the top portion 48 of the radioisotope generator 22. FIG. 5 is a top perspective view of the radioisotope generator 22 disposed inside the cylindrical receptacle 46 of the auxiliary shield 12 without the alignment adapter 34.

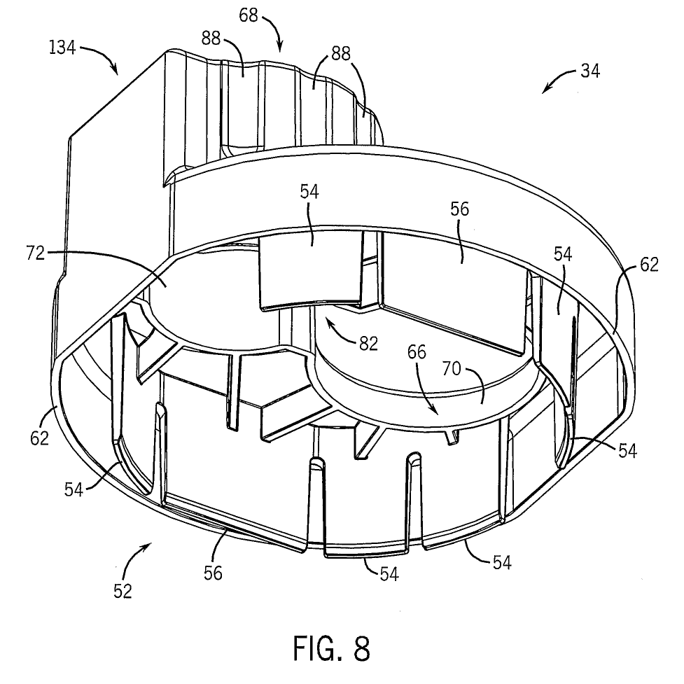

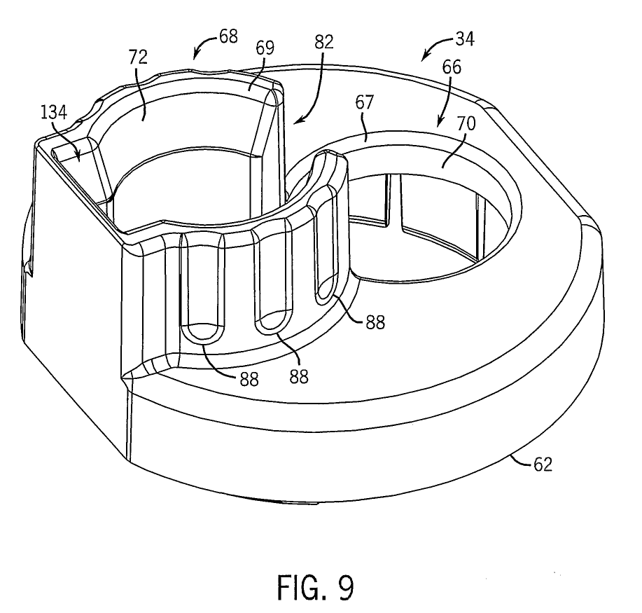

Referring now to the alignment adapter 34 illustrated in FIGS. 6, 7, 8, and 9 along with the elution system 10 illustrated in FIGS. 3 and 4, a bottom side 52 of the alignment adapter 34 may include a plurality of alignment tabs, e.g., a plurality of curved tabs 54 and a pair of flat opposite tabs 56. The alignment tabs of an alignment adapter may be employed to engage or fit relatively closely with one or more features of the top portion 48 of the radioisotope generator 22. For instance, the curved and flat tabs 54, 56 may be employed to engage or fit relatively closely with curved sides 58 and flat opposite sides 60 of the top portion 48 of the radioisotope generator 22. In view of the relatively small clearance between the tabs 54, 56 and the top portion 48, the alignment adapter 34 is relatively firmly secured and balanced relative to the radioisotope generator 22. Although not illustrated, these tabs 54, 56 and the grooves, openings, and recesses between the tabs 54, 56 and the bottom side 52 of the alignment adapter 34 may provide storage space for the flexible handle 50 of the radioisotope generator 22. This storage space may reduce a likelihood of the flexible handle 50 interfering with a desired (e.g., balanced) fit between the alignment adapter 34 and the radioisotope generator 22.

The bottom side 52 of the alignment adapter 34 as illustrated in FIGS. 3, 6, and 8 may include a generally curved or partially cylindrical outer side wall 62, which may generally exhibit substantially similar shape and dimensions as at least a portion of the receptacle 46 of the auxiliary shield 12. In view of these substantially similar shapes and dimensions, the cylindrical outer side wall 62 may be said to fit relatively snugly within the cylindrical receptacle 46 of the auxiliary shield 12. In this manner, the alignment adapter 34, in at least one regard, generally aligns, closely-fits, and removably holds the top portion 48 of the radioisotope generator 22 within the auxiliary shield 12. While the alignment adapter 34 is shown as having an outer side wall 62 that is at least generally substantially similar in shape and dimensions to the receptacle 46 of the auxiliary shield 12, other embodiments of the alignment adapter 34 may include any appropriate design of the outer side wall 62 that, when disposed on a generator, promotes or at least generally assists in maintaining a desired position of the generator relative to an auxiliary shield which houses the generator.

Referring back to FIG. 5, a gap 64 may exist between a cylindrical exterior 65 of the radioisotope generator 22 and the cylindrical receptacle 46 inside the auxiliary shield 12 without the alignment adapter 34. Turning now to FIG. 10, the alignment adapter 34 may be disposed over the top portion 48 of the radioisotope generator 22 prior to or after the generator 22 being placed in the auxiliary shield 12. As illustrated in FIG. 10, the cylindrical outer sidewall 62 of the alignment adapter 34 fits relatively closely inside the cylindrical receptacle 46, thereby effectively obviating the gap 64 between the radioisotope generator 22 and the cylindrical receptacle 46 at the top portion 48 of the radioisotope generator 22. Accordingly, the alignment adapter 34 may be utilized to promote and maintain proper alignment and positioning of the generator (e.g., the inlet and outlet hollow needles 28, 30 thereof) relative to the auxiliary shield 12.

As illustrated with reference to FIGS. 3, 4, 6, 8, and 9, the alignment adapter 34 may have a first container alignment passage (e.g., a lower passage) 66 and a second container alignment passage (e.g., an upper protruded passage) 68 defined therein. These passages 66, 68 may exhibit any appropriate shapes/designs. For instance, the passages 66, 68 are shown as having generally cylindrical shaped interiors 70, 72 for receiving the container 24 and elution assembly 14 with relatively small clearance. As illustrated in FIG. 10, the alignment adapter 34 is closely fit against (e.g., snugly interfaces with) the cylindrical receptacle 46 and the radioisotope generator 22, such that the passages 66, 68 are securely positioned over the inlet and outlet hollow needles 28, 30. In addition, the cylindrical shaped interiors 70, 72 of the respective passages 66, 68 are preferably (but not necessarily always) generally centered relative to the inlet and outlet hollow needles 28, 30, respectively. In this manner, and as illustrated in FIGS. 3 and 4, the alignment adapter 34 may increase the likelihood that a technician can closely guide the container 24 and elution assembly 14 in desired manners toward (e.g., straight toward and centered with) the hollow needles 28, 30 as indicated by centerlines 74, 76, respectively. Thus, the alignment adapter 34 may effectively obviate undesirable gaps and play between the components, thereby substantially reducing the likelihood of undesirably tilting and/or misaligning the container 24 and elution assembly 14 relative to the hollow needles 28, 30, respectively. Entryways of the illustrated passages 66, 68 include chamfers 67, 69 to facilitate initial insertion of the eluant container 24 and elution assembly 14. These chamfers 67, 69 may, at least in one regard, be utilized to facilitate proper entry of the container 24 and the elution assembly 14 into the corresponding passages 66, 68 even if the container 24 and the elution assembly 14 are initially misaligned with the alignment adapter 34. Again, the close-fitting of the container 24 and the elution assembly 14 within passages 66, 68 increases the likelihood that the container 24 and the elution assembly 14 may engage and disengage the hollow needles 28, 30 in a desired orientation and position (e.g., relatively straight and centered direction along the centerlines 74, 76).

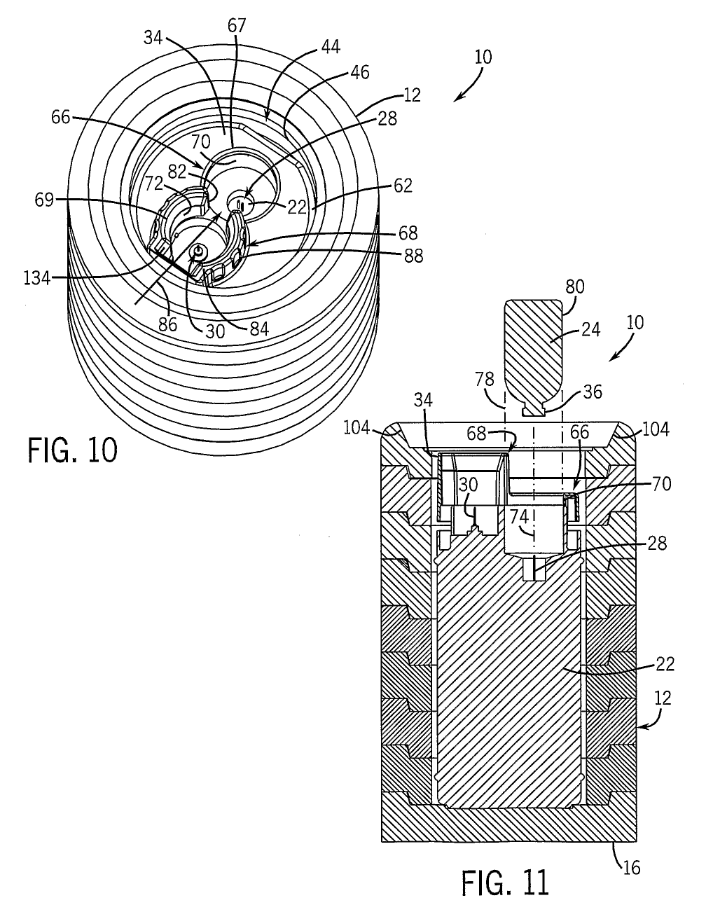

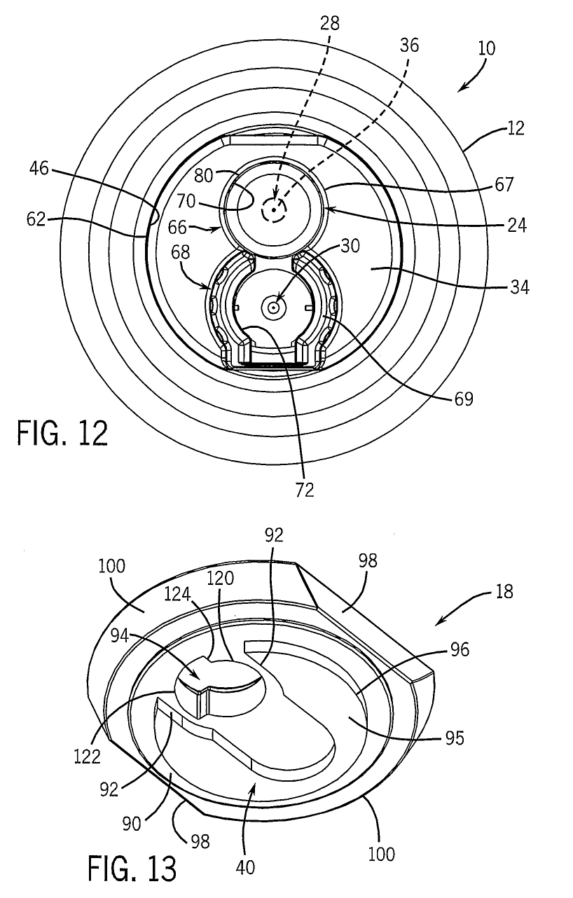

FIG. 11 is a cross-sectional side view of the elution system 10 of FIG. 10, further illustrating the eluant container 24 exploded relative to the alignment adapter 34 and the radioisotope generator 22 disposed within the cylindrical receptacle 46 of the auxiliary shield 12. As indicated by dashed lines 78, an exterior 80 of the eluant container 24 has a shape and dimensions that closely fit within the interior 70 of the first container alignment passage 66. In view of the relatively close fit or reduced play between the eluant container 24 and the first container alignment passage 66, the alignment adapter 34 reduces the likelihood of tilting, laterally shifting, or generally misaligning the eluant container 24 (and the end 36 thereof) relative to the inlet hollow needles 28 during insertion and removal. In the illustrated embodiment, the alignment adapter 34 enables a user to guide and align the components in a relatively straight direction, such that the inlet hollow needles 28 enter and separate from the end 36 of the eluant container 24 in a generally straight direction at a generally central position of the end 36. As illustrated, the end 36 of the eluant container 24 and the inlet hollow needles 28 are aligned generally along (e.g., generally parallel with) the centerline 74. FIG. 12 is a top view of the elution system 10 of FIG. 11 illustrating the eluant container 24 centered over the first container alignment passage 66 of the alignment adapter 34 and the inlet hollow needles 28 of the radioisotope generator 22.

Referring again to FIG. 10, the alignment adapter 34 includes an eluant viewing window 82 defined, at least in part, by a C-shaped geometry 84 of the second container alignment passage 68. The eluant viewing window 82 is disposed on an open end of the C-shaped geometry 84 adjacent the first container alignment passage 66. As illustrated in FIG. 6, the eluant viewing window 82 may be characterized as an opening, passage, or slot that extends between the first and second container alignment passages 66, 68. Although not illustrated in FIG. 10, if the eluant container 24 is disposed within the first container alignment passage 66 in engagement with the inlet hollow needles 28, then a user may be able to view a level of eluant within the eluant container 24 through the eluant viewing window 82 as indicated by arrow 86. As discussed in further detail below, the user, at least in some embodiments, may be able to view the eluant level through the viewing window 82 when the lid 18 is disposed over the alignment adapter 34 and the auxiliary shield 12. In embodiments of the alignment adapter that include a viewing window, a user may be able to at least roughly determine a level of eluant remaining within the eluant container 24 without completely disassembling the elution system 10. While one embodiment of an appropriate viewing window has been described above, other alignment adapters may include any of a number of other appropriate designs for a viewing window(s).

In addition to the eluant viewing window 82, the alignment adapter 34 of FIG. 10 includes a ribbed grip 88 on the exterior of the second container alignment passage 68. While the ribbed grip 88 is shown as a series of elongate channels defined in the exterior surface of second container alignment passage 68, a “ribbed grip” herein refers to any surface features and/or texturing provided to promote a user's grasping and/or holding of the alignment adapter 34. As such, this ribbed grip may be utilized, as least in one regard, to at least generally facilitate installation and removal of the alignment adapter 34 relative to the radioisotope generator 22 and the auxiliary shield 12. Moreover, the protruded nature of the second container alignment passage 68 may reduce a likelihood that a user will touch one of the hollow needles 28, 30 on the radioisotope generator 22 (e.g., during interconnection and/or dissociation of the alignment adapter and the generator).

Turning now to the lid 18 of FIG. 13 and with reference back to the exploded elution system 10 of FIGS. 3 and 4, the supplemental alignment adapter 40 may be adhered or generally fixed to an underside 90 of the lid 18. While not shown some embodiments include a supplemental alignment adaptor (or at least a portion thereof) that is integral with the lid 18. The supplemental alignment adapter 40 has opposite interior sides 92 positioned generally symmetrically about an assembly passage 94 through the lid 18. These opposite interior sides 92 have a generally curved shape to fit around the C-shaped geometry 84 of the second container alignment passage 68 of the alignment adapter 34 and also the cylindrical shaped exterior 80 of the eluant container 24. As such, the second container alignment passage 68 and the eluant container 24 are able to be recessed within the supplemental alignment adapter 40 when the lid 18 is properly aligned and seated with the auxiliary shield 12.

The supplemental alignment adapter 40 of FIG. 13 may be characterized as a generally C-shaped disk structure 95 having a generally C-shaped or partially cylindrical exterior surface 96, which facilitates alignment and a relatively close fit within the cylindrical receptacle 46 of the auxiliary shield 12. The lid 18 includes a pair of opposite flat sides 98 and a pair of opposite curved sides 100 to facilitate insertion and removal of the lid 18 relative to the auxiliary shield 12. For example, the opposite flat sides 98 may provide a pair of opposite recesses or gaps for a user to grab the lid 18 during insertion and removal relative to the auxiliary shield 12. The opposite curved sides 100 are generally tapered (e.g., angled, wedge-shaped, partially conical, or the like) to guide the lid 18 toward a closely-fit centered position within the upper opening 44 of the auxiliary shield 12.

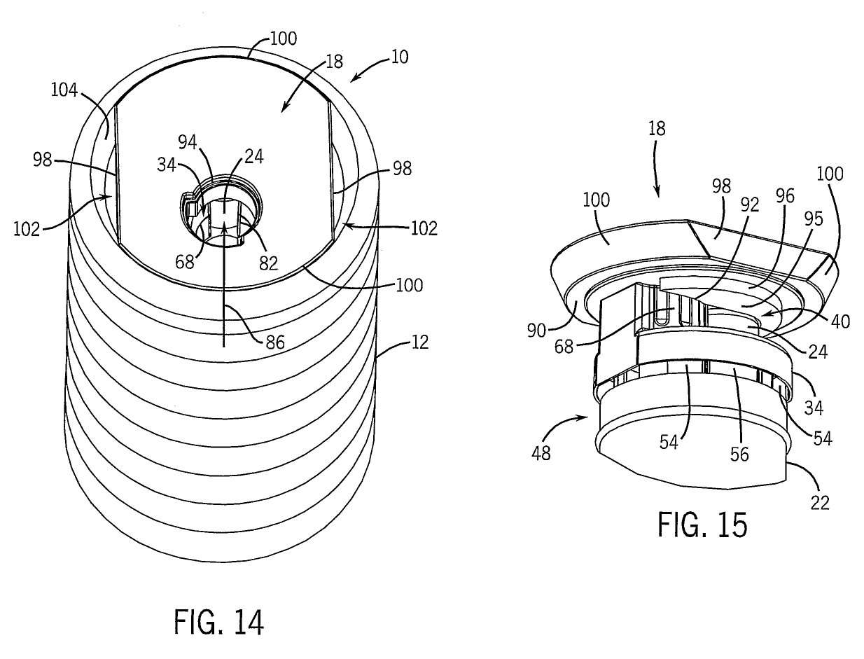

Referring to FIG. 14 is a top perspective view of the elution system 10 of FIGS. 11 and 12, further illustrating the lid 18 of FIGS. 1-4 and 11 disposed over and covering the upper opening 44 of the auxiliary shield 12. As illustrated, the assembly passage 94 defined in the lid 18 is generally aligned with the second container alignment passage 68 of the alignment adapter 34. In this position achieved via employment of the alignment adapter 34 and the supplemental alignment adapter 40, the eluant container 24 can be viewed through the passage 94 in the lid 18 and through the viewing window 82 in the alignment adapter 34 as indicated by the arrow 86. Accordingly, a user may determine the eluant level within the eluant container 24 without removing the lid 18.

As further illustrated in FIG. 14, the opposite flat sides 98 of the lid 18 leave small recesses or openings 102 between the lid 18 and the upper interior of the auxiliary shield 12. The illustrated openings 102 have the form of opposite segments of a circle. These openings 102 enable a user to grip the opposite flat sides 98 of the lid 18 for insertion and removal relative to the auxiliary shield 12. Other embodiments of the lid 18 may exhibit any of a number of other appropriate designs for the sides of the lid 18 to provide one or more at least partial openings between the lid and the auxiliary shield 12 to facilitate a user in removing the lid.

The auxiliary shield 12 of FIG. 14 includes a tapered or angled cylindrical interior surface 104, which may slidingly interface with the opposite curved sides 100 of the lid 18 during covering and/or exposing the receptacle 46 of the auxiliary shield 12. This interface between the lid 18 and the interior surface 104 of the auxiliary shield 12 may function to guide the lid 18 toward a desired (e.g., closely fit centered) position over the upper opening 44 of the receptacle 46.

The C-shaped exterior surface 96 of the supplemental alignment adapter 40 may tend to interface with the interior of the receptacle 46, thereby promoting proper alignment of the lid 18 relative to the receptacle 46. As mentioned above, the opposite interior sides 92 of the supplemental alignment adapter 40 may include a recessed region at least generally fit to the shape and dimensions of the second container alignment passage 68 of the alignment adapter 34 and the eluant container 24. During installation, the lid 18 may not completely lower or become seated until the opposite interior sides 92 of the supplemental alignment adapter 40 are aligned properly with the C-shaped geometry 84 of the second container alignment passage 68 and the eluant container 24. In this manner, the supplemental alignment adapter 40 may be said to increase a likelihood that the assembly passage 94 of the lid 18 becomes properly aligned with the second container alignment passage 68 of the alignment adapter 34 and, thus, with the output hollow needle 30 disposed on the radioisotope generator 22 below the alignment adapter 34.

FIG. 15 is a partial bottom perspective view of the elution system 10 of FIG. 14 without the auxiliary shield 12 for illustration of the interaction between the alignment adapter 34 and the supplemental alignment adapter 40. As illustrated, the lid 18 is aligned with the radioisotope generator 22 via the interface between the alignment adapter 34 and the supplemental alignment adapter 40. For example, the opposite interior sides 92 of the supplemental alignment adapter 40 are disposed around at least a portion of the exterior of the second container alignment passage 68 of the alignment adapter 34 and around at least a portion of the exterior of the eluant container 24 in the illustrated configuration in which the lid 18 is fully seated into the opening 44 of the auxiliary shield 12. During installation of the lid 18, the supplemental alignment adapter 40 on the underside 90 of the lid 18 functions to hold up the lid 18 until the recess (e.g., between the opposite interior sides 92) is properly aligned with the first container alignment passage 66 and the eluant container 24. Once aligned properly, the recess in the supplemental alignment adapter 40 enables a user to position the lid 18 to cover and fully seat with the opening 44 of the auxiliary shield 12. At this aligned position, the passage 94 is preferably properly aligned with the second container alignment passage 68 and the output hollow needle 30 disposed on the radioisotope generator 22 below the alignment adapter 34.

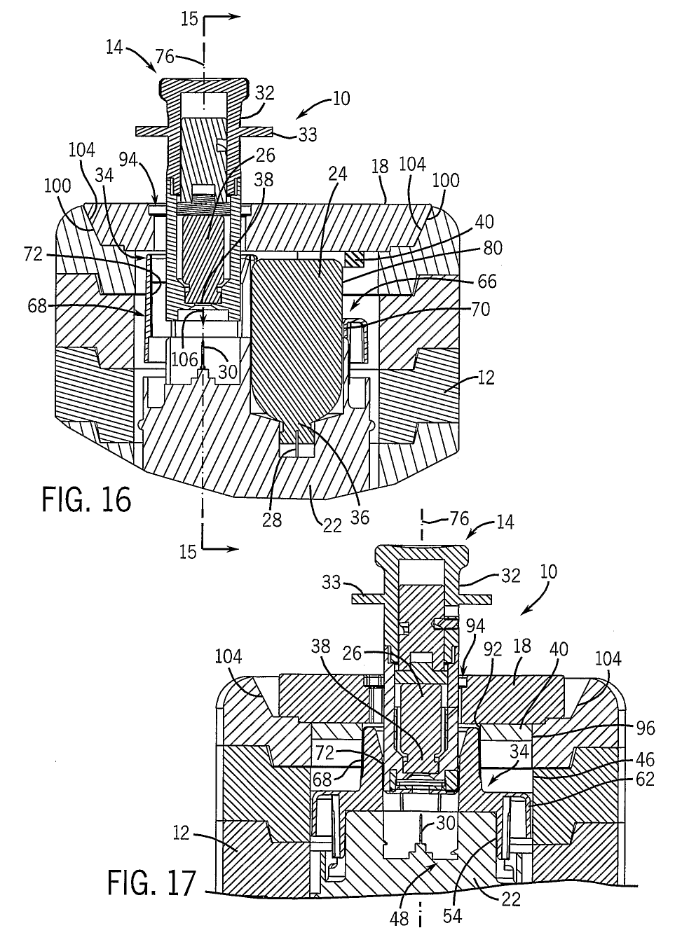

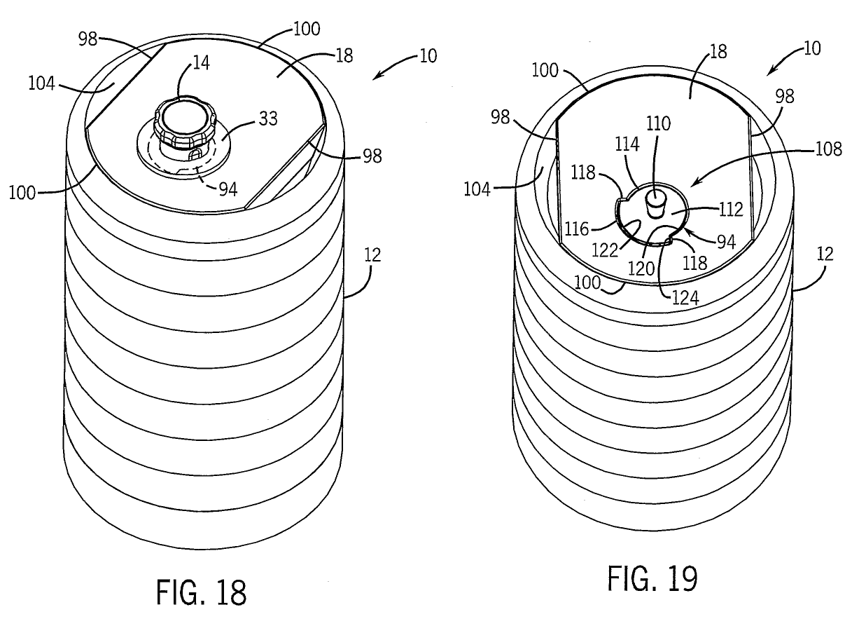

FIGS. 16 and 17 are partial cross-sectional side views of the elution system 10 of FIG. 15 illustrating the shielded elution assembly 14 partially extended through the assembly passage 94 above the output hollow needle 30. As indicated by arrow 106, the alignment adapter 34 assists a technician in guiding the shielded elution assembly 14 in a substantially straight direction along the center line 76 of the output hollow needle 30 and the eluate container 26. At least a portion of the exterior shape and dimensions of the shielded elution assembly 14 closely fit with the inner shape and dimensions of the protruded passage 68, thereby substantially minimizing clearance between the assembly 14 and the protruded passage 68. In this manner, the alignment adapter 34 may reduce the likelihood of misalignment, tilting, and/or damage to the components of the elution system 10 during insertion and/or removal of the shielded elution assembly 14 relative to the output hollow needle 30 of the radioisotope generator 22. FIG. 18 is a top perspective view of the shielded elution assembly 14 fully installed through the lid 18 into the auxiliary shield 12 in engagement with the output hollow needle 30 of the radioisotope generator 22.

FIG. 19 is a top perspective view of the elution system 10 of FIGS. 16 and 17, illustrating a lid plug 108 (rather than the shielded elution assembly 14) disposed within the passage 94. As illustrated, the lid plug 108 effectively occludes the passage 94 to reduce the likelihood of radiation (e.g., from the radioisotope generator 22 disposed inside the auxiliary shield 12) escaping through the passage 94. The illustrated lid plug 108 includes a protruding grip or peg 110 extending from a head portion of a body 112 of the plug 108, such that a user can easily grab the lid plug 108 for insertion into and removal from the passage 94. The head portion of the body 112 includes a first arcuate (e.g., semi-circular) outer wall or shape 114, a second arcuate (e.g., semi-circular) outer wall or shape 116, and intermediate angled outer walls or portions 118. These shapes 114, 116 and angled portions 118 are closely fit with mating shapes 120, 122 and angled portions 124 of the passage 94, thereby facilitating proper alignment of the lid plug 108 relative to the lid 18 and the components disposed inside the elution system 10. The lid plug 18 is at least partially made of lead and/or another suitable radiation shielding material.

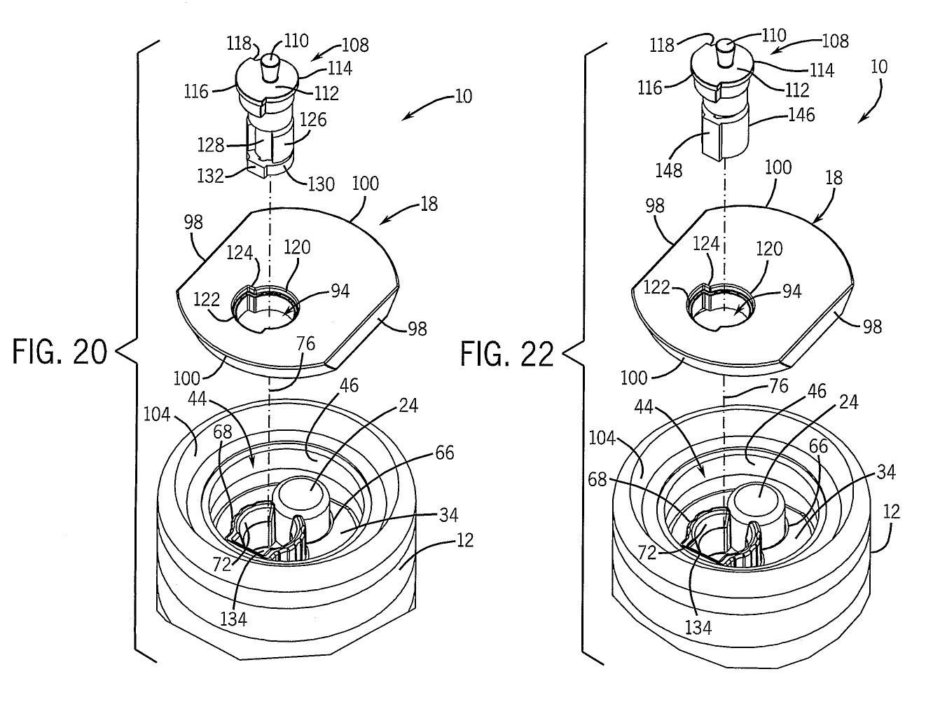

FIG. 20 is a partial perspective exploded view of the elution system 10 of FIG. 19, illustrating one embodiment of the lid plug 108 exploded from the lid 18 and the alignment adapter 34 disposed within the auxiliary shield 12. As illustrated, the lid plug 108 includes a partially cylindrical or C-shaped alignment sleeve 126 disposed removably about a mid-portion 128 of the body 112. The illustrated C-shaped alignment sleeve 126 is made of a plastic material or other flexible material, which can resiliently fit around the mid-portion 128. The C-shaped alignment sleeve 126 effectively increases the thickness or diameter of the mid-portion 128 along most of the body 112. In view of the increased dimensions, the C-shaped alignment sleeve 126 closely fits the mid-portion 128 to the dimensions of the cylindrical shaped interior 72 of the second container alignment passage 68 of the alignment adapter 34. In this manner, the C-shaped alignment sleeve 126 promotes a relatively small clearance between the lid plug 108 and the cylindrical shaped interior 72 during at least most of the insertion and removal of the lid plug 108 relative to the alignment adapter 34. For these reasons, the C-shaped alignment sleeve 126 may be defined as a fitted-mounting alignment portion of the body 112.

In addition, the lid plug 108 of FIG. 20 includes a semi-cylindrical base 130 having an alignment tab 132, which fits within a rectangular slot or groove 134 in the second container alignment passage 68 of the alignment adapter 34. The alignment tab 132 facilitates proper alignment of the lid plug 108 relative to the alignment adapter 34 and, in turn, the outlet hollow needle 30 disposed on the radioisotope generator 22.

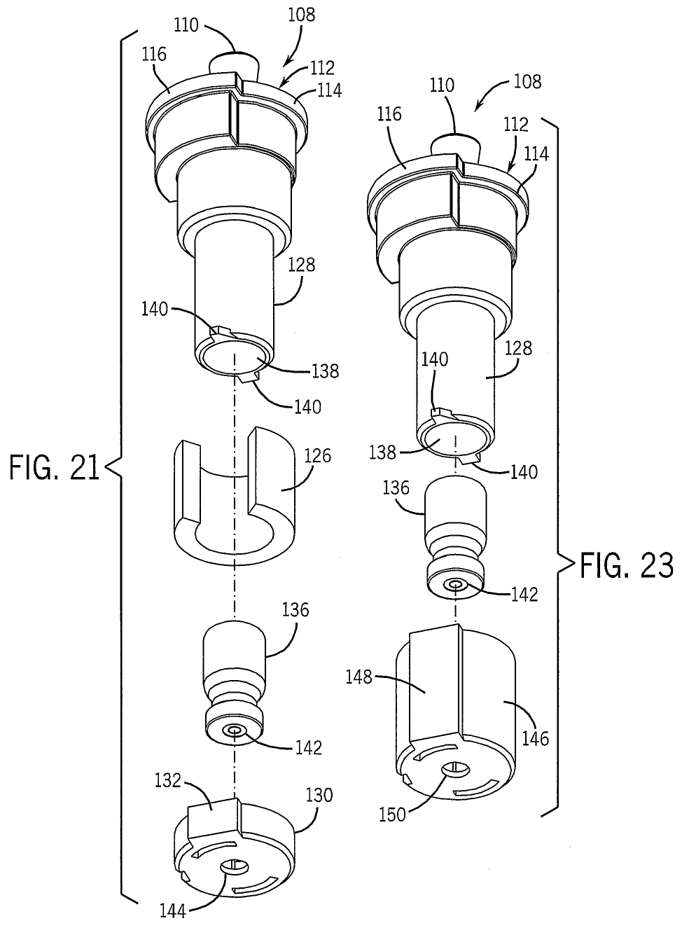

FIG. 21 is a bottom perspective exploded view of the lid plug 108 of FIG. 20, further illustrating a sterile fluid container 136. The sterile fluid container 136 fits inside the mid-portion 128 in a receptacle 138, which is subsequently covered by the semi-cylindrical base 130. The base 130 attaches to the mid-portion 128 by latchingly rotating the base 130 into engagement with latches or tabs 140 disposed on the mid-portion 128. The illustrated sterile fluid container 136 contains a sterile fluid (e.g., TechneStat™), which is accessed through a hollow needle passage 142. The base 130 also has a passage 144 to enable the outlet hollow needle 30 disposed on the radioisotope generator 22 to pass into the sterile fluid container 136. When the lid plug 108 is fully installed within the elution system 10, the outlet hollow needle 30 extends through the passage 144 in the base 130 and through the hollow needle passage 142 into the sterile fluid container 136, thereby increasing the likelihood that the hollow needle 30 remains sterile until the next elution process is performed.

FIG. 22 is a top perspective exploded view of the elution system 10 of FIG. 19, illustrating an alternative embodiment of the lid plug 108 exploded from the lid 18 and the alignment adapter 34 within the auxiliary shield 12. As illustrated, the lid plug 108 of FIG. 22 has a semi-cylindrical alignment structure 146 and a protruding guide portion or alignment rail 148 disposed along a substantial portion of the length of the lid plug 108. The shape and dimensions of this semi-cylindrical alignment structure 146 and the alignment rail 148 are closely fit with the shape and dimensions of the cylindrical shaped interior 72 and rectangular slot or groove 134 of the second container alignment passage 68 of the alignment adapter 34. The relatively small clearance between the semi-cylindrical alignment structure 146 and the cylindrical shaped interior 72 of the second container alignment passage 68 promotes the lid plug 108 moving straight through the alignment adapter 34 without tilting or shifting relative to the output hollow needle 30. In addition, the alignment rail 148 is designed to slide along the rectangular slot or groove 134, thereby facilitating proper alignment of the lid plug 108 relative to the alignment adapter 34. For these reasons, the semi-cylindrical alignment structure 146 and/or the alignment rail 148 may be defined as a fitted-mounting alignment portion of the body 112.

FIG. 23 is a bottom perspective exploded view of the lid plug 108 of FIG. 22, further illustrating the sterile fluid container 136. As illustrated, the sterile fluid container 136 fits within the mid-portion 128 in the receptacle 138. The semi-cylindrical alignment structure 146 extends over the mid-portion 128 and rotatingly latches with the latches or tabs 140. Similar to the base 130 of FIGS. 20 and 21, the semi-cylindrical alignment structure 146 includes a passage 150 to facilitate insertion and removal of the output hollow needle 30 relative to the hollow needle passage 142 of the sterile fluid container 136. However, the illustrated semi-cylindrical alignment structure 146 extends along the entire mid-portion 128. Thus, in contrast to the embodiment of FIGS. 20 and 21, the semi-cylindrical alignment structure 146 integrates the C-shaped alignment sleeve 126 and base 130 into a single structure. Again, the shape and dimensions of this semi-cylindrical alignment structure 146 are closely fit and aligned with the shape and dimensions of the second container alignment passage 68 of the alignment adapter 34. In view of this close fit and alignment, the semi-cylindrical alignment structure 146 facilitates alignment of the lid plug 108 relative to the alignment adapter 34 and the output hollow needle 30 of the radioisotope generator 22.

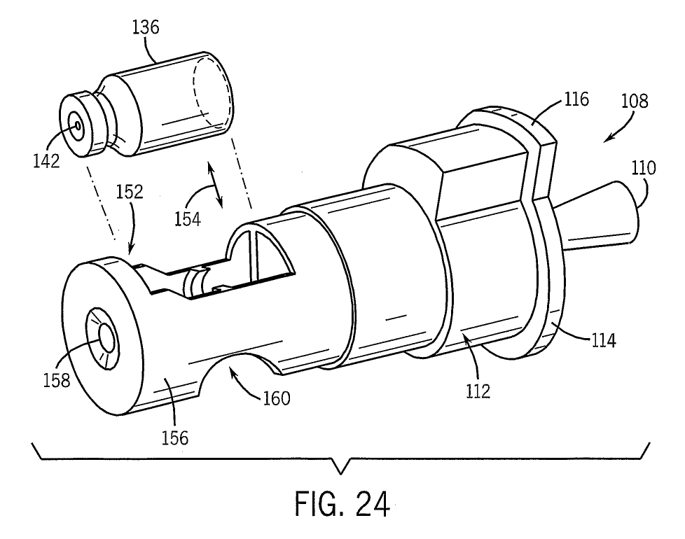

FIG. 24 is a bottom perspective view of another alternative embodiment of the lid plug 108 of FIG. 19. The lid plug 108 of FIG. 24 includes a lateral access receptacle 152 for insertion and removal of the sterile fluid container 136 in a lateral direction 154. As illustrated, the body 112 of the lid plug 108 includes a cylindrical external shape 156 along a substantial portion of the length of the body 112. The dimensions of this cylindrical external shape 156 are closely fit with those of the cylindrical shaped interior 72 of the second container alignment passage 68 of the alignment adapter 34. Accordingly, the cylindrical external shape 156 substantially minimizes the clearance between the lid plug 108 and the cylindrical shaped interior 72 of the second container alignment passage 68 during at least most of the insertion and removal of the lid plug 108 relative to the alignment adapter 34. For these reasons, the cylindrical external shape 156 may be defined as a fitted-mounting alignment portion of the body 112. In addition, the illustrated lid plug 108 is a one-piece structure, which eliminates the multiple parts and complexities associated with other designs. In certain embodiments, the lateral access receptacle 152 includes latches, snap-fit mechanisms, friction fit mechanisms, and/or other appropriate mechanisms to secure the sterile fluid container 136 removably in a centered position within the body 112.

When installed within the lateral access receptacle 152, the sterile fluid container 136 is generally centered such that the hollow needle passage 142 is aligned with a passage 158 at the end of the lid plug 108. The lid plug 108 also includes a removal access hole 160 on an opposite side from the lateral access receptacle 152. This removal access hole 160 enables a user to press the sterile fluid container 136 outwardly from a mounted position within the lateral access receptacle 152. In this manner, the lateral access receptacle 152 and removal access hole 160 facilitate easy insertion and removal of the sterile fluid container 136, and preferably without assembling or disassembling components of the lid plug 108.

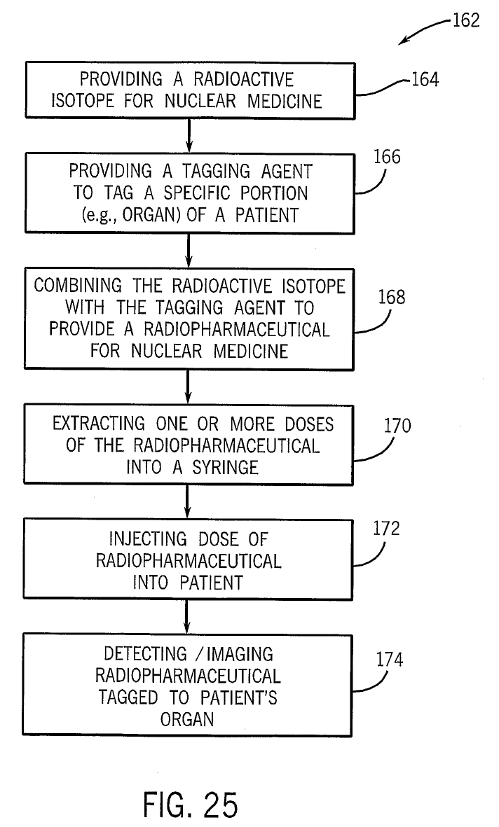

FIG. 25 is a flowchart illustrating an exemplary nuclear medicine process utilizing the radioactive isotope produced by the elution system 10 illustrated with reference to FIGS. 1-24. As illustrated, the process 162 begins by providing a radioactive isotope for nuclear medicine at block 164. For example, block 164 may include eluting technetium-99m from the radioisotope generator 22 illustrated and described in detail above. At block 166, the process 162 proceeds by providing a tagging agent (e.g., an epitope or other appropriate biological directing moiety) adapted to target the radioisotope for a specific portion, e.g., an organ, of a patient. At block 168, the process 162 then proceeds by combining the radioactive isotope with the tagging agent to provide a radiopharmaceutical for nuclear medicine. In certain embodiments, the radioactive isotope may have natural tendencies to concentrate toward a particular organ or tissue and, thus, the radioactive isotope may be characterized as a radiopharmaceutical without adding any supplemental tagging agent. At block 170, the process 162 then may proceed by extracting one or more doses of the radiopharmaceutical into a syringe or another container, such as a container suitable for administering the radiopharmaceutical to a patient in a nuclear medicine facility or hospital. At block 172, the process 162 proceeds by injecting or generally administering a dose of the radiopharmaceutical into a patient. After a pre-selected time, the process 162 proceeds by detecting/imaging the radiopharmaceutical tagged to the patient's organ or tissue (block 174). For example, block 174 may include using a gamma camera or other radiographic imaging device to detect the radiopharmaceutical disposed on or in or bound to tissue of a brain, a heart, a liver, a tumor, a cancerous tissue, or various other organs or diseased tissue.

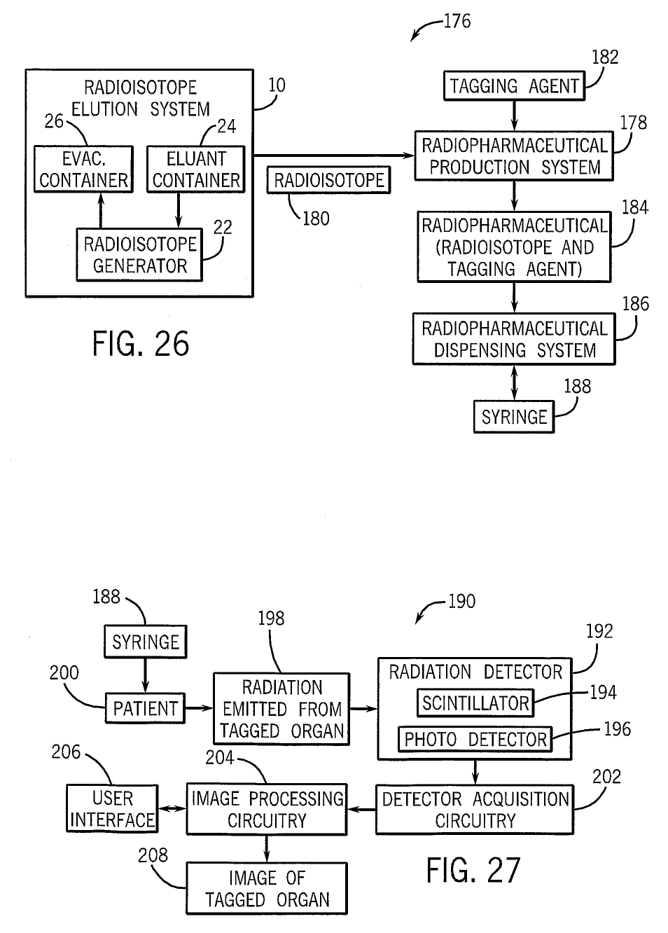

FIG. 26 is a block diagram of an exemplary system 176 for providing a syringe having a radiopharmaceutical disposed therein for use in a nuclear medicine application. As illustrated, the system 176 includes the radioisotope elution system 10 previously described with regard to FIGS. 1-24. The system 176 also includes a radiopharmaceutical production system 178, which functions to combine a radioisotope 180 (e.g., technetium-99m solution acquired through use of the radioisotope elution system 10) with a tagging agent 182. In some embodiment, this radiopharmaceutical production system 178 may refer to or include what are known in the art as “kits” (e.g., Technescan(® kit for preparation of a diagnostic radiopharmaceutical). Again, the tagging agent may include a variety of substances that are attracted to or targeted for a particular portion (e.g., organ, tissue, tumor, cancer, etc.) of the patient. As a result, the radiopharmaceutical production system 178 produces or may be utilized to produce a radiopharmaceutical including the radioisotope 180 and the tagging agent 182, as indicated by block 184. The illustrated system 176 may also include a radiopharmaceutical dispensing system 186, which facilitates extraction of the radiopharmaceutical into a vial or syringe 188. In certain embodiments, the various components and functions of the system 176 are disposed within a radiopharmacy, which prepares the syringe 188 of the radiopharmaceutical for use in a nuclear medicine application. For example, the syringe 188 may be prepared and delivered to a medical facility for use in diagnosis or treatment of a patient.

FIG. 27 is a block diagram of an exemplary nuclear medicine imaging system 190 utilizing the syringe 188 of radiopharmaceutical provided using the system 176 of FIG. 26. As illustrated, the nuclear medicine imagining system 190 includes a radiation detector 192 having a scintillator 194 and a photo detector 196. In response to radiation 198 emitted from a tagged organ within a patient 200, the scintillator 194 emits light that is sensed and converted to electronic signals by the photo detector 196. Although not illustrated, the imaging system 190 also can include a collimator to collimate the radiation 198 directed toward the radiation detector 192. The illustrated imaging system 190 also includes detector acquisition circuitry 202 and image processing circuitry 204. The detector acquisition circuitry 202 generally controls the acquisition of electronic signals from the radiation detector 192. The image processing circuitry 204 may be employed to process the electronic signals, execute examination protocols, and so forth. The illustrated imaging system 190 also includes a user interface 206 to facilitate user interaction with the image processing circuitry 204 and other components of the imaging system 190. As a result, the imaging system 190 produces an image 208 of the tagged organ within the patient 200. Again, the foregoing procedures and resulting image 208 directly benefit from the radiopharmaceutical produced by the elution system 10 as illustrated and described with reference to FIGS. 1-24.

While the invention may be susceptible to various modifications and alternative forms, specific embodiments have been shown by way of example in the figures and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A radioisotope elution system, comprising:
a radioisotope generator;
an eluant container; and
an alignment adapter comprising an eluant alignment portion and an eluate alignment portion coupled together, wherein the alignment adapter is releasably interconnected with the radioisotope generator, wherein the eluant container is substantially aligned in a releasable connection with the radioisotope generator by the eluant alignment portion, and wherein the eluant alignment portion is configured such that the eluant container is coupled to an inlet hollow needle of the radioisotope generator.

2. The system of claim 1, wherein the eluant alignment portion of the alignment adapter comprises a first passage closely fit about the eluant container and aligned with an inlet hollow needle of the radioisotope generator.

3. The system of claim 2, wherein the eluate alignment portion of the alignment adapter comprises a second passage aligned with an outlet hollow needle of the radioisotope generator.

4. The system of claim 3, wherein the second passage comprises an upper protruded passage.

5. The system of claim 4, wherein the upper protruded passage comprises an outer grip.

6. The system of claim 4, wherein the upper protruded passage comprises a viewing window adjacent the eluant container.

7. The system of claim 3, comprising an elution assembly including a radiation-shielding elution shield, and an eluate container disposed within the elution shield, wherein the elution assembly is substantially aligned in another releasable connection with the outlet hollow needle via the second passage.

8. The system of claim 1, comprising an auxiliary radiation shield having a receptacle and an opening into the receptacle, and a cover removably disposed across the opening, wherein the radioisotope generator is disposed inside the receptacle below the cover, and the alignment adapter is disposed between the radioisotope generator and the cover.

9. The system of claim 8, wherein the alignment adapter comprises an outer wall closely fit within the receptacle, and an inner structure closely fit about a top side of the radioisotope generator.

10. The system of claim 8, comprising a supplemental alignment adapter coupled to an underside of the cover, wherein a passage in the cover is substantially aligned with a corresponding passage in the alignment adapter and with a connector of the radioisotope generator via at least one supplemental alignment structure of the supplemental alignment adapter.

11. The system of claim 10, wherein the supplemental alignment adapter comprises a recess having sides closely fit with outer dimensions of the eluant container, or an elution assembly, or a lid plug, or a combination thereof.

12. The system of claim 8, comprising a lid plug having a sleeve closely fit within a passage through the cover, wherein the lid plug includes a sterile fluid container disposed in a radiation-shielding body.

13. The system of claim 8, comprising a lid plug disposed in a passage through the cover, wherein the lid plug includes a lateral access receptacle holding a container.

14. The system of claim 1, wherein the alignment adapter comprises a handle storage region adjacent the radioisotope generator.

15-22. (canceled)

23. A radioisotope generator assembly, comprising:
a radioisotope generator comprising a first hollow needle; and
an alignment adapter closely fit with a top portion of the radioisotope generator, wherein the alignment adapter comprises a first passage substantially centered relative to the first hollow needle, the first passage is shaped to fit closely with dimensions of a first container coupleable with the first hollow needle, wherein the alignment adapter comprises an elution viewing window extending into the first passage.

24. The radioisotope generator assembly of claim 23, wherein the first passage comprises a protruded structure having the elution viewing window.

25. The radioisotope generator assembly of claim 23, comprising a second passage having a second hollow needle of the radioisotope generator at least partially disposed therein, and the second passage is shaped to fit closely with dimensions of a second container coupleable with the second hollow needle.

26. The radioisotope generator assembly of claim 23, wherein the alignment adapter comprises an outer wall shaped to fit closely with dimensions of a receptacle of an auxiliary shield.

27. The radioisotope generator assembly of claim 23, wherein the radioisotope generator comprises a parent radioisotope for a radiopharmaceutical.

28. A method, comprising:
guiding a first container through a closely fit first passage of a structure releasably attached to a radioisotope generator, the guiding of the first container comprising guiding the first container into engagement with a first hollow needle of the radioisotope generator; and
guiding a second container through a closely fit second passage of the structure into engagement with a second hollow needle of the radioisotope generator.

29. The method of claim 28, comprising adapting outer dimensions of the radioisotope generator to fit closely within a receptacle of an auxiliary radiation shield.

30. The method of claim 29, comprising adapting outer dimensions of a lid plug to fit closely within a passage of a cover disposed over an opening into the receptacle.

31. The method of claim 28, comprising circulating an eluant from the first container, through the first hollow needle into the radioisotope generator, and out through the second hollow needle into the second container to elute a radioisotope from within the radioisotope generator.

32-50. (canceled)
